(19) United States
(12) Patent Application Publication
(10) Pub. No.: US 2001/0042202 A1
(43) Pub. Date: Nov. 15, 2001

(54) Dynamically extendible firewall

(76) Inventors: Charles J. Horvath, Concord, MA (US); Lei Cao, Nashua, NH (US)

Correspondence Address: TESTA, HURWITZ & THIBEAULT, LLP, HIGH STREET TOWER, 125 HIGH STREET, BOSTON, MA, 02110, US

(21) Appl. No.: 09/819,328

(22) Filed: Mar. 28, 2001

Related U.S. Application Data
(63) Continuation-in-part of application No. 09/550,230, filed on Apr. 14, 2000.

(51) Int. Cl. H04L 9/00

(52) U.S. Cl. 713/154

(57) ABSTRACT

A method for dynamically-extending a firewall includes a step of receiving an identifier from a remote system. The identifier is used locally to accept packets of information with matching identifiers, rejecting packets whose identifiers do not match.

### CLAIM OF PRIORITY

This application is a continuation-in-part of pending application Ser. No. 09/550,230, filed on Apr. 14, 2000, the entire disclosure of which is incorporated by reference herein.

### FIELD OF THE INVENTION

The present invention relates to a method for dynamically extending a firewall upon the establishment of a connection with a remote system, and in particular, to a firewall method that enables the rejection of network traffic from non-approved sources.

### BACKGROUND OF THE INVENTION

Information systems are evolving to become the delivery mechanism that drives corporate revenues. In industries ranging from financial services to on-line shopping, the computer has become the business. Accordingly, protection of computer-based data is becoming of paramount importance to a corporation's financial well being.

Customer support for such information systems needs to be rapid. For mission-critical information systems, a delay of even a few hours while waiting for a service engineer to arrive to diagnose the system can be disastrously expensive. Attempts have been made to address this problem by providing a service network to which a computer system is able to connect. However, such systems can be expensive to create and maintain because they must be capable of connecting to each and every customer requiring support. Further, the identity and locations of clients seeking support changes rapidly, requiring constant reconfiguration of the service network.

Moreover, existing service networks have faced some resistance due to perceived security problems connection of client systems to the service provider's network limit the security of both networks. Accordingly, a robust service network that is dynamically configurable and secure is desirable.

### SUMMARY OF THE INVENTION

The present invention provides a firewall technique that is dynamically extendible upon the establishment of connections with a remote system.

In one aspect the present invention relates to a method for dynamically extending a firewall. The method includes the step of establishing a connection with a remote system. A connection, in some embodiments a serial connection; is initiated with the remote system and the remote system assigns identifiers to the local system. In some embodiments, the identifier is an IP address transmitted to the client system.

### BRIEF DESCRIPTION OF THE DRAWINGS

The invention is pointed out with particularity in the appended claims. The advantages of the invention described above, as well as further advantages of the invention, may be better understood by reference to the following description taken in conjunction with the accompanying drawings, in which:

FIG. 1 is a block diagram of an embodiment of a traditional computer system;

FIG. 2 is a block diagram of an embodiment of a redundant, fault-tolerant computer system;

FIG. 3 is a block diagram showing an embodiment of auxiliary connections between service management logic units, processors, and I/O controllers in the system of FIG. 2;

FIGS. 4 and 4A are block diagrams depicting an embodiment of the steps to be taken during initialization of a fault-tolerant computer system;

FIGS. 5 and 5A are screen shots depicting exemplary embodiments of user interfaces for controlling the booting process;

FIG. 6 is a block diagram depicting one embodiment of a service network;

FIG. 7 is a block diagram depicting one embodiment of a POP server as shown in FIG. 6;

FIG. 8 is a functional flow diagram of one embodiment of the steps to be taken to initiate a client connection from a service network;

FIG. 9 is a block diagram of one embodiment of the system management logic of FIG. 3;

FIG. 10 is a diagram showing the internals of one embodiment of the arbiter 930 of FIG. 9;

FIG. 11 is a state diagram of the PCI state machine 1000 of FIG. 10; and

FIG. 12 is a state diagram of the priority state machine 1002 of FIG. 10.

### DETAILED DESCRIPTION OF THE INVENTION

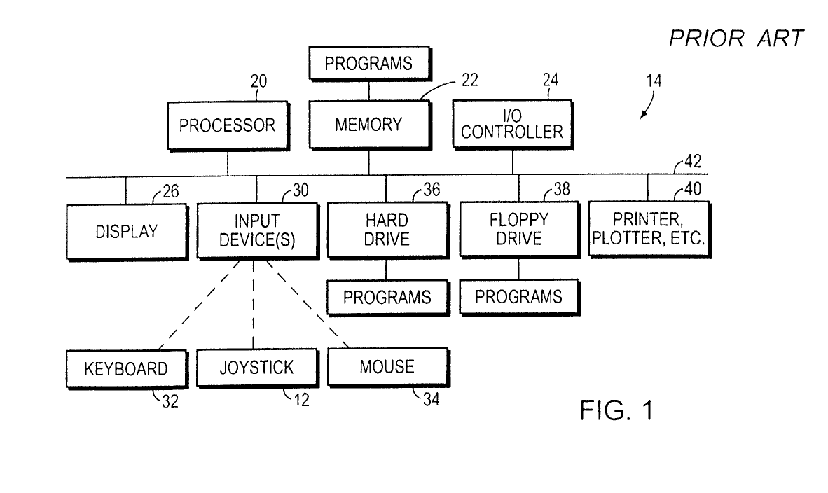

Referring now to FIG. 1, a typical computer 14 as known in the prior art includes a central processor 20, a main memory unit 22 for storing programs and/or data, an input/output (I/O) controller 24, a display device 26, and a data bus 42 coupling these components to allow communication between these units. The memory 22 may include random access memory (RAM) and read only memory (ROM) chips. The computer 14 typically also has one or more input devices 30 such as a keyboard 32 (e.g., an alphanumeric keyboard and/or a musical keyboard), a mouse 34, and, in some embodiments, a joystick 12.

The computer 14 typically also has a hard disk drive 36 and a floppy disk drive 38 for receiving floppy disks such as 3.5-inch disks. Other devices 40 also can be part of the computer 14 including output devices (e.g., printer or plotter) and/or optical disk drives for receiving and reading digital data on a CD-ROM. In the disclosed embodiment, one or more computer programs define the operational capabilities of the system 10. These programs can be loaded onto the hard drive 36 and/or into the memory 22 of the computer 14 via the floppy drive 38. Applications may be caused to run by double clicking a related icon displayed on the display device 26 using the mouse 34. In general, the controlling software program(s) and all of the data utilized by the program(s) are stored on one or more of the computer's storage mediums such as the hard drive 36, CD-ROM 40, etc.

System bus 42 allows data to be transferred between the various units in the computer 14. For example, processor 20 may retrieve program data from memory 22 over system bus 42. Various system busses 42 are standard in computer systems 14, such as the Video Electronics Standards Association Local Bus (VESA Local Bus), the industry standard architecture ISA bus (ISA), the Extended Industry Standard Architecture bus (EISA), the Micro Channel Architecture bus (MCA) and the Peripheral Component Interconnect bus (PCI). In some systems 14 multiple busses may be used to provide access to different units of the system. For example, a system 14 may use a PCI to connect a processor 20 to peripheral devices 30, 36, 38 and concurrently connect the processor 20 to main memory 22 using an MCA bus.

It is immediately apparent from FIG. 1 that such a traditional computer system 14 is highly sensitive to any single point of failure. For example, if main memory unit 22 fails to operate for any reason, the computer 14 as a whole will cease to function. Similarly, should system bus 42 fail, the system 14 as a whole will fail. A redundant, fault-tolerant system achieves an extremely high level of availability by using redundant components and data paths to insure uninterrupted operation. A redundant, fault-tolerant system may be provided with any number of redundant units. Configurations include dual redundant systems, which include duplicates of certain hardware units found in FIG. 1, and triply redundant configurations, which include three of each unit shown in FIG. 1. In either case, redundant central processing units 20 and main memory units 22 run in “lock step,” that is, each processor runs identical copies of the operating system and application programs. The data stored in replicated memory 22 and registers provided by the replicated processors 20 should be identical at all times.

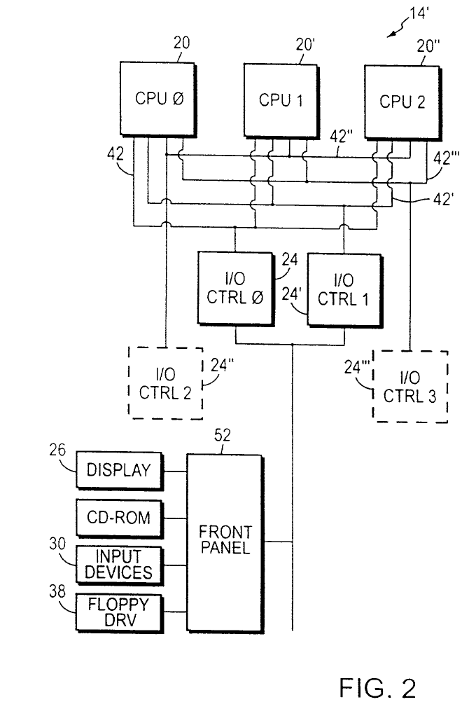

Referring now to FIG. 2, one embodiment of a redundant, fault-tolerant system 14′ is shown that includes three processors 20, 20′, 20″ (generally 20) and at least two input output controllers 24, 24′ (generally 24). As shown in FIG. 2, system 14′ may include more than two input output controllers (24″ and 24′″ shown in phantom view) to allow the system 14′ to control more I/O devices. In the embodiment shown in FIG. 2, four redundant system busses 42, 42′, 42″ and 42′″ (generally 42) are used to interconnect each processor 20 and I/O controllers 24. In one embodiment, processors 20 are selected from the “x86” family of processors manufactured by Intel Corporation of Santa Clara, Calif. The x86 family of processors includes the 80286 processor, the 80386 processor, the 80486 processor, and the Pentium, Pentium II, Pentium III, and Xeon processors. In another embodiment processors are selected from the “680x0” family of processors manufactured by Motorola Corporation of Schaumburg, Ill. The 680x0 family of processors includes the 68000, 68020, 68030, and 68040 processors. Other processor families include the Power PC line of processors manufactured by the Motorola Corporation, the Alpha line of processors manufactured by Compaq Corporation of Houston, Texas, and the Crusoe line of processors manufactured by Transmeta Corporation of Santa Clara, Calif.

Each processor 20 may include logic that implements fault-tolerant support. For embodiments in which CPU 20 is a single chip, the fault-tolerant logic may be included on the chip itself. In other embodiments, the CPU 20 is a processor board that includes a processor, associated memory, and fault-tolerant logic. In these embodiments, the fault-tolerant logic can be implemented as a separate set of logic on processor board 20. For example, the fault-tolerant logic may be provided as an application specific integrated circuit (ASIC), a field programmable gate array (FPGA), an electrically erasable programmable read-only memory (EEPROM), a programmable read-only memory (PROM), a programmable logic device (PLD), or a read-only memory device (ROM). The fault-tolerant logic compares the results of each operation performed by the separate processors 20 to the results of the same operation performed on one of the other processors 20. If a discrepancy is determined then a failure has occurred.

Each input output controller may also include fault-tolerant logic that monitors transactions on the system busses 42 to aid in determining a processor failure. As shown in FIG. 2, the I/O controller boards 24 also provide support for the display 26, input devices 30 and mass storage such as floppy drives 38, hard drives, and CD-ROM devices. The embodiment shown in FIG. 2 includes a front panel 52 that provides an interface to these input and output devices. In these embodiments, the front panel may serve as an adapter between the I/O controllers 24 and, for example, a universal serial bus (USB) used by keyboard and mouse input devices, or a video connector (EGA, VGA, or SVGA) used for connecting displays to the system 14′.

Each I/O controller 24 includes service management logic which performs various system management functions, such as: monitoring the operational status of the system; performing online diagnostics of the system; and providing an interface for remotely viewing system operation (including a processor boot sequence). In some embodiments, the service management logic includes a modem providing a serial line connection to a service network. In other embodiments, the service management logic includes a connection for communicating with other customer equipment, such as an Ethernet connection of other local area network connection. In some embodiments, the service management logic is provided as a separate board that is in communication with I/O controller 24. In one particularly preferred embodiment, a service management board including all service management logic connects to I/O controller 24 via a PCI slot. The service management logic (referred to hereafter as SML) may be provided with a power supply separate from the remainder of the system 14′.

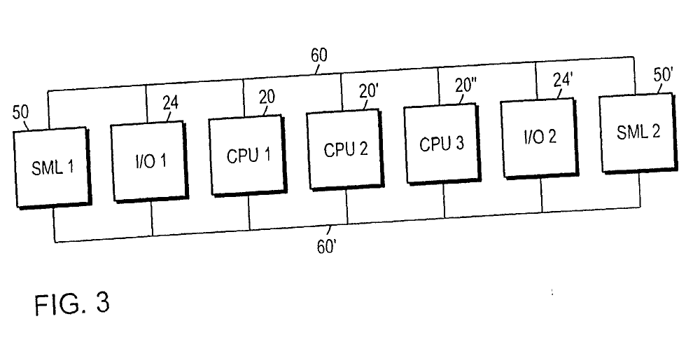

Referring now to FIG. 3, a block diagram shows the connection between SML units 50, 50′ (generally 50) and the I/O controllers 24, 24′ and processors 20, 20′, 20″ of the system 14′. As shown by FIG. 3, each SML 50 is connected to each of the other units by redundant auxiliary busses 60, 60′ in addition to redundant busses 42. Auxiliary busses 60, 60′ may be any bus that allows the SMLs 50 to control and query the processors 20 and I/O controllers 24. The SMLs can communicate with the other units using a variety of connections including twisted pair, broadband connections, or wireless connections. Connections can be established using a variety of lower layer communication protocols such as TCP/IP, IPX, SPX, Ethernet, RS232, direct asynchronous connections, or I²C. In general, any message-oriented protocol may be used, and a check-summed, packet-oriented protocol is preferred.

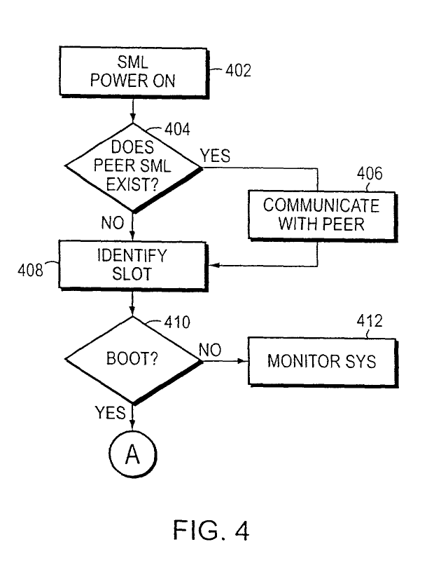

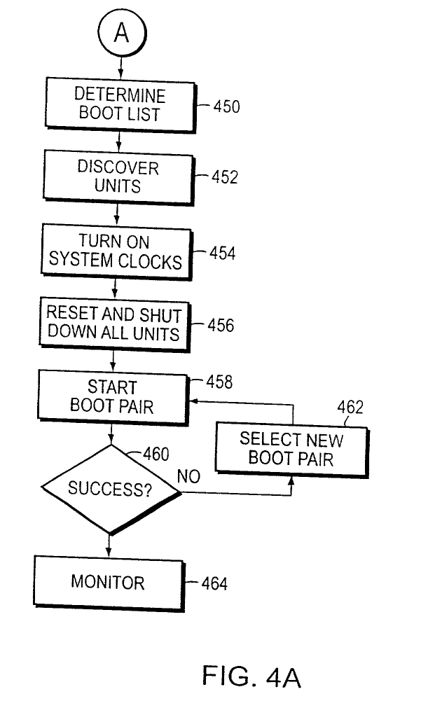

Referring now to FIG. 4, the steps to be taken to boot a redundant, fault-tolerant system are shown. In brief overview, the boot process begins by powering on the SMLs (step 402), initializing and communicating with other SMLs in the system (steps 404, 406 and 408), and determining whether or not the system requires booting (step 410).

In greater detail, and as noted above, SMLs 50 are provided with power separate from the power provided to the system 14′. Power is supplied to the SMLs (step 402) before any other units in the system 14′. For embodiments in which the SML is a portion of an I/O controller board 24, power may be supplied to the entire I/O controller board 24 but only routed to the SML portion of the controller board 24. For embodiments in which the SML is provided as a separate board, then only the SML is supplied with power. In either case, whether and when power is supplied to the other units in the system is under the direct control of the SML.

A SML uses auxiliary busses 60, 60′ to determine if other SMLs exist in the system (step 404). If so, the SMLs exchange messages over the auxiliary busses 60, 60′ in order to determine which SML will function as the primary SML for the system 14′ (step 406). The determination of which SML will function as the primary SML may include many factors, including: whether or not a service management logic unit has been previously inserted in the system to be powered up; and whether another SML has already been powered up and is operational. In other embodiments, the identity of the primary SML may be “hardwired.”

If an SML 50 determines that no other SML exists in the system 14′, or if an SML 50 has determined that it will function as the primary SML 50 for a system 14′ with multiple SMLs, the SML identifies with which I/O controller 24 it is associated (step 408). The SML 50 uses this information during the boot process to determine if another SML 50 should act as the primary SML 50 during the boot process. For example, if the I/O controller with which the SML 50 is associated is not selected for booting, then the SML 50 associated with the booting I/O controller must act as the primary SML 50 for the boot attempt. In other words, BIOS heartbeat and other boot status messages will be directed to the SML 50 on the booting I/O controller, even if that SML 50 is not the primary SML 50.

Once an SML determines that it is the primary SML for a system 14′, it determines whether or not to boot the system 14′. SMLs 50 can exchange messages to negotiate which SML 50 is the primary SML 50. If an SML 50 is already functioning in the system as primary, then a peer SML 50 becomes secondary. If neither SML 50 has yet been identified as the primary SML 50, the SMLs 50 negotiate to determine which SML 50 is the primary SML 50. In one embodiment the SMLs 50 negotiate to determine which SML 50 is the primary SML 50. In one embodiment, the SMLs 50 negotiate using the following rules:

1. If one SML 50 is “alien” to the system then the SML 50 which is not alien becomes primary. “Alien” means that the SML 50 was not resident in the computer system the last time it was used.

2. If one SML 50 was primary more recently than the other, it becomes the primary again (and the other becomes secondary).

3. As a default, the SML 50 in I/O board slot 0 becomes the primary SML 50. The SML 50 in I/O board slot 1 becomes secondary.

A service management logic unit, in this embodiment, will not boot the system if it was explicitly shut down by an administrator (for example, if the administrator used a “power off” command to shut down the system). Whether or not a system has been explicitly shut down by an administrator may be stored in non-volatile memory (not shown in the drawings) that the SML 50 may query.

If a SML 50 determines that it should not boot the system 14′, it transitions to a state in which it monitors the system (step 412). This state is described in greater detail below. For example, an SML 50 may query a non-volatile memory element and discover that the system 14′ was properly and explicitly shut down by an administrator. In this case, the SML 50 will not attempt to boot the system 14′. Otherwise, the system moves to the boot process described in FIG. 4A.

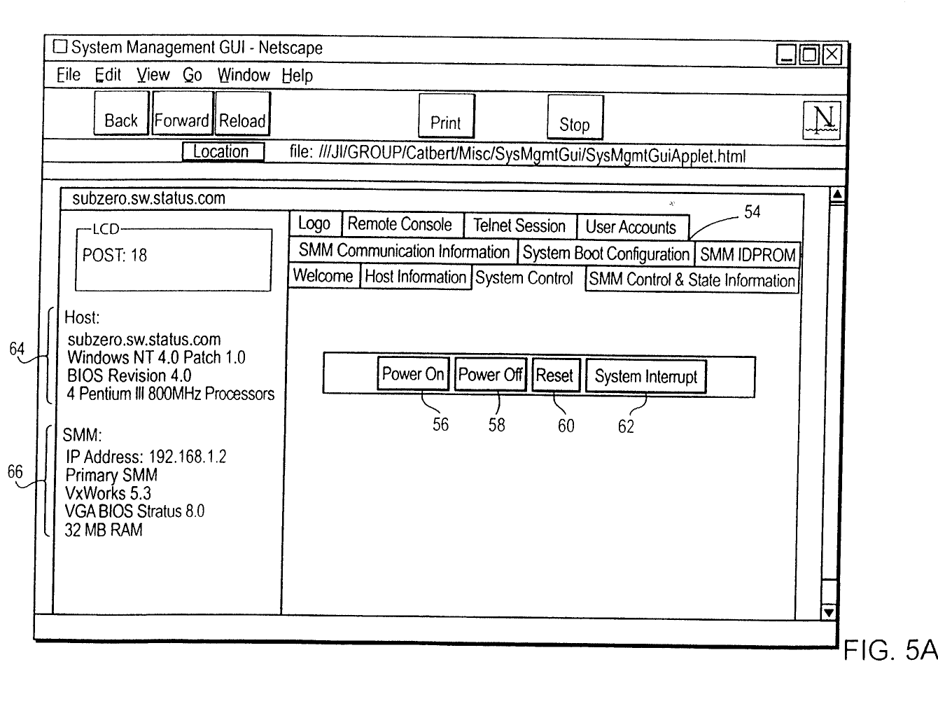

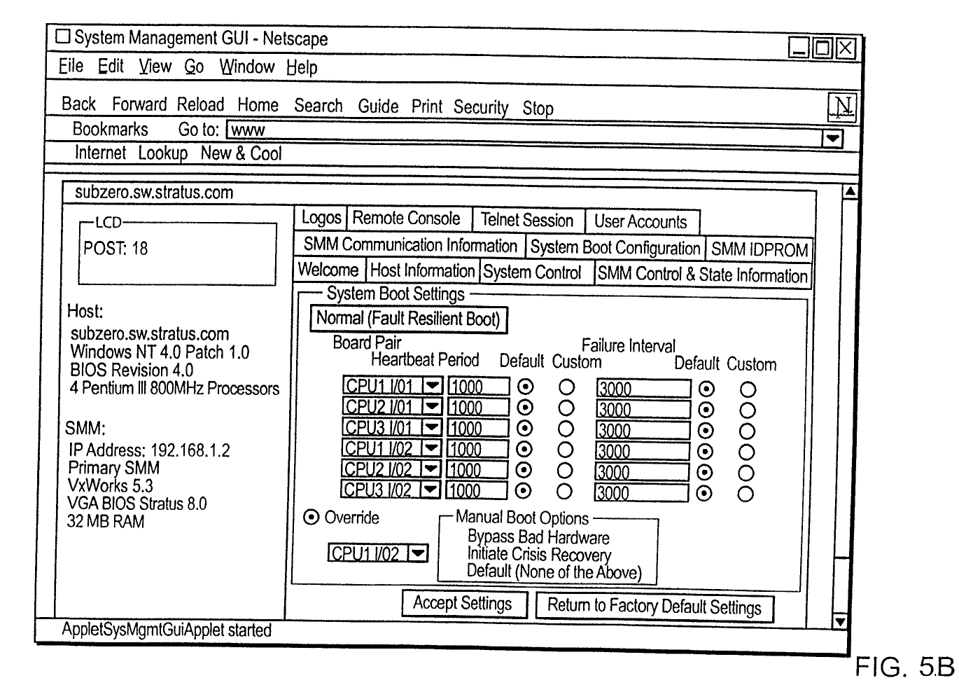

The boot process shown in FIG. 4A may be commenced by an initializing SML 50. Alternatively, the boot process may be directly invoked by a system administrator by, for example, a “boot” command. FIG. 5A is a screen shot showing an exemplary embodiment for providing such commands to the system administrator by the primary SML 50. In this embodiment, system administration commands are grouped as a set of “tabs” and displayed to the administrator. The administrator selects the tab containing the desired operations. FIG. 5A depicts an embodiment in which a “System Control” tab 54 provides four controls for a system: a “Power On” command 56 (depicted in gray to indicate the system is currently running; an explicit “Power Off” command 58; a “Reset” command 60; and a “System Interrupt” command 62. System information 64, as well as information concerning the primary SML 66, is provided to the administrator. In the embodiment shown in FIG. 5A, the administration commands are provided using a browser-based user interface. Although FIG. 5A depicts an embodiment using NETSCAPE NAVIGATOR, manufactured by Netscape Communications of Mountain View, Calif., any browser may be used, including MICROSOFT INTERNET EXPLORER, manufactured by Microsoft Corporation of Redmond, Wash. A third way for the boot process shown in FIG. 4A to be invoked is by an SML following a system failure. This mechanism is discussed in greater detail below.

The boot process begins by determining a “boot list” (step 450) FIG. 4A. A boot list is a list of component systems allowing the system to boot. For example, boot components may include processors, I/O controllers, BIOS, and other software (both application and system). In one particular embodiment, a boot list an ordered list of processor-I/O controller pairs. In some embodiments, the boot list includes “heartbeat” values associated with each boot pair. Heartbeat values are used by an SML 50 during system operation to determine if a processor 20 is functioning properly. Heartbeats are described in greater detail below. The boot list may be stored in a data structure that associates processor identification values with I/O controller values. For embodiments in which heartbeat values are also stored, the data structure includes an additional field to associate heartbeat timer values with each boot pair. The data structure may be stored on each SML 50 in a system 14′. In preferred embodiments, the data structure is stored in an non-volatile, erasable memory element, such as an EEPROM, that is accessible using auxiliary busses 60, 60′. In the event that the stored data structure is inconsistent (for example the data structure may include corrupted data values), or if the SML 50 is unable to retrieve data from the memory element (for example, if no memory element exists or if both auxiliary busses 60, 60′ are not functioning), the SML 50 may use a hard-coded default list.

FIG. 5B depicts a screen shot of an exemplary user interface allowing a system administrator to modify the default boot list. As shown in connection with FIG. 5A, the user interface is browser based and provides information to the administrator regarding the system 14′ and SML 50 currently active. Once the graphical user interface shown in FIG. 5B is used to create a boot list, it is saved to the non-volatile memory element.

Once a boot list is determined, whether by retrieving a list from a memory element or by using a default list, the SML 50 determines available processors 20 and I/O controllers 24 (step 452). The SML 50 may transmit a message over auxiliary busses 60, 60′ to determine this information. Processors 20 and I/O controller 24 respond to the message transmitted by the SML 50. The SML 50 concludes that a processor 20 or I/O controller does not exist if no response to the message is received on either bus 60, 60′. This information is used by the SML 50 to skip pairs in the boot list if they reference units not present in the system 14′.

Once all system units are discovered by the SML 50, the SML 50 provides system clocks to the processors 20 and the I/O controllers 24 (step 452). In other embodiments system clocks are not under the control of the SML 50 and, in these embodiments, step 452 may be skipped.

Using auxiliary busses 60, 60′, the SML 50 asserts a reset signal associated with each processor 20 and I/O controller 24 (step 456). The SML 50 takes any other steps necessary at this point to prepare all system units for booting. For example, some units may need to have power applied or, for example, certain other signals may need to be asserted to prepare the unit for booting.

The SML releases reset from the processor 20 and the I/O controller 24 identified in the boot list as the first boot pair while holding reset active for all other system units (step 458). This allows the selected boot pair to boot in a manner consistent with a traditional computer. The SML 50 monitors the boot process of the selected boot pair to determine if the boot process is successful (step 460). In one embodiment, the SML 50 monitors the progress of the boot process by receiving heartbeat signals from the booting process-I/O controller pair. In one embodiment, heartbeats are transmitted over system busses 40. Failure to receive a heartbeat signal within a predetermined time period indicates that the boot process has failed. If the boot process is not successful, the SML 50 selects a new boot pair from the boot list (step 462) and attempts to boot that processor-I/O controller pair. In some embodiments, the Basic Input-Output System (BIOS) may, during the boot attempt, determine that it cannot achieve a proper boot of the operating system , even though the processor has booted and is providing heartbeat signals to the SML 50. In this case, the BIOS issues an explicit “reboot” command to the SML 50 and the SML 50 selects a new boot pair from the boot list.

If the SML 50 cycles through every pair identified in the boot pair list and none of the pairs is successful, the SML 50 indicates that the system 14′ was unable to boot. In some embodiments the SML 50 removes all power from the processors 20 and the I/O controllers 24 after determining the system 14′ is unable to boot.

If the boot process is successful, the BIOS transmits a message to the SML indicating that the operating system has booted properly. In this case, the SML transitions to a monitoring state (step 464). In some embodiments, after successfully booting the first processor-I/O pair the SML 50 boots each other processor 20 in the system 14′.

Once the booting process is complete, or if the SML 50 determines that the system 14′ should not be booted, the SML 50 enters a monitoring state (steps 412 or 464). In this state the SML 50 monitors heartbeat signals from each of the processors 20 to determine operation status of the system 14′. A failure to receive a heartbeat signal from a processor 20 during a predetermined period indicates that a failure has occurred. In this event, the SML 50 consults a non-volatile memory element to determine what actions, if any to take. The memory element may be the same memory element discussed above that stores the boot list, or a separate memory element may be provided that is accessible via the auxiliary busses 60, 60′. In one embodiment, the memory element stores a value that indicates one of seven actions for the SML 50 to take upon heartbeat failure: (1) no action; (2) normal interrupt; (3) non-maskable interrupt; (4) stop processor from executing; (5) system reboot; or (6) deterministic boot. Each of these options is discussed in detail below.

A memory value indicating that the SML 50 should take no action on a heartbeat failure disables all recovery mechanisms. In some embodiments, the SML 50 logs the failure but otherwise does nothing.

A memory value indicating “normal interrupt” restricts recovery attempts by the SML 50 to issuing normal interrupts to the processor 20 or processors 20 that have ceased to transmit a heartbeat. In this embodiment, the SML 50 issues an interrupt to a target processor 20 via the auxiliary busses 60, 60′. If the processor's operating system is able to process the interrupt, it responds by restarting heartbeat transmission. In some embodiments, the operating system ensures that lockstep processing is resumed. In other embodiments, the SML 50 issues interrupts to the processor or processors such that the processors resume lockstep operation. For example, interrupts may be issued to processors simultaneously which should avoid breaking lockstep. In some embodiments the operating system halts execution of all programs and allows a system administrator to debug system settings. If the operating system does not respond to the interrupt, then recovery fails. In some embodiments, the SML 50 simply logs this failure. In other embodiments, the SML 50 alerts an administrator that the system 14′ will not respond.

A memory value indicating “non-maskable interrupts” restricts recovery attempts by the SML 50 to issuing normal and non-maskable interrupts to the processor 20 or processors 20 that have ceased to transmit a heartbeat. In this embodiment, should the system 14′ refuse to respond to a normal interrupt, the SML 50 issues a non-maskable interrupt to a target processor 20 via the I/O controller 24. If multiple processors 20 are hung, non-maskable interrupts are issued to all processors 20 in lockstep to avoid breaking processor lockstep. If the processor's operating system is able to process the non-maskable interrupt, it responds by restarting heartbeat transmission. In this case, the SML 50 must revoke the previously issued normal interrupt. In some embodiments the operating system halts execution of all programs and allows a system administrator to debug system settings. If the operating system does not respond to the non-maskable interrupt, then recovery fails. In some embodiments, the SML 50 simply logs this failure. In other embodiments, the SML 50 alerts an administrator that the system 14′ will not respond.

A memory value indicating that processor execution should be suspended allows the SML 50, in the event that a non-maskable interrupt fails to restore system operation, to select a processor 20 and suspend execution of all applications and the operating system by that processor 20. Processor and memory state of the suspended processor is not destroyed. If heartbeat signals resume from the other processors once the selected processor 20 is suspended, recovery has been successful. The state of the suspended processor 20 may be dumped for analysis, the state of the suspended processor may be replaced with state from one of the operational processors 20, or both. If this step fails to restore the system 14′ to operational status, the SML 50 may dump the state of the suspended processor 20 for analysis by a system administrator, log the failure, alert an administrator to the failure, or any combination of these actions.

A memory value indicating “system reboot” allows the SML 50 to attempt to reboot the system in the event that suspended a selected processor 20 does not succeed. The reboot process is similar to the reboot process described in connection with FIGS. 4 and 4A, except that the suspended processor 20 is skipped during reboot of the boot pairs listed in the boot list. To avoid repetitive heartbeat failure, the SML 50 maintains an index to identify the last processor-I/O boot pair in the boot list that last rebooted successfully. During the reboot process, this index is incremented to ensure that a different pair is selected as the starting pair each time. If successful, the state of the suspended processor 20 may be dumped for analysis, the state of the suspended processor 20 may be replaced with the state of one of the operational processors, or both. As above, if this mechanism doesn't succeed in restoring the system 14′ to operational status, the SML 50 may dump the state of the suspended processor 20 for analysis by a system administrator, log the failure, alert an administrator to the failure, or any combination of these actions.

A memory value indicating “deterministic boot” allow the SML 50 to abandon the state of the suspended board and perform a full deterministic reboot, as described in connection with FIGS. 4 and 4A.

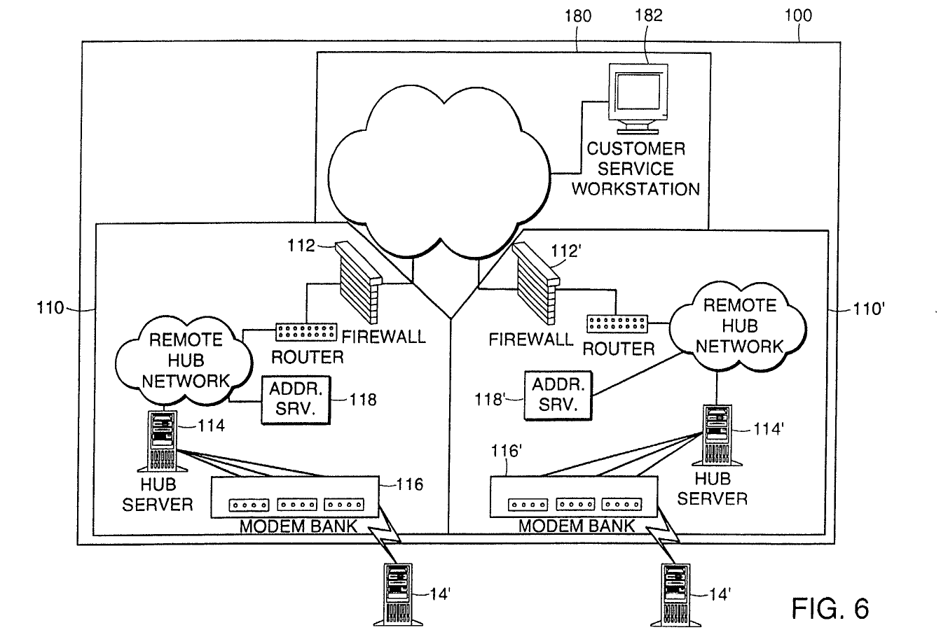

Referring now to FIG. 6, the system management features of the SML 50 can be extended by providing the SML 50 with the capability of connecting to a service network 100. The service network allows support personnel 182 to access, configure, or otherwise manipulate connected computer systems 14′ via their respective SMLs 50. The service network 100 also allows the SML 50 to report specific problems or failures it has detected with the system 14′. An example of the types of failures reported are those resulting from failure of a heartbeat signal, as described above.

The embodiment of a service network 100 shown in FIG. 6 includes two remote “points of presence” 110, 110′0 and a centralized support provider network (SPN) 180. Points of presence 110, 110′ provide geographically localized access to the centralized network 180. For example, the centralized SPN 180 may be located in Glasgow, Scotland. Point of presence 110 may be located in Boston, United States of America. In this embodiment, POP 110 provides a computer system 14′ in Boston with access to the SPN 180 in Scotland while avoiding the expense attendant with making a direct connection to the SPN 180 in Scotland. POPs 110, 110′ connect with the centralized SPN 180 through a firewall 112, 112′. Firewalls 112, 112′ secure the SPN 180 against malicious client-side activity.

Each POP 110, 110′ includes a POP server 114, 114′ that is responsible for establishing and managing network connections to individual computer systems 14, 14′ and an address server 118′ that manages the assignment of IP addresses to computer systems 14′. In one embodiment, the address server 118′ is a Dynamic Host Configuration Protocol (DHCP) server. In another embodiment, the address server 118′ is a customized server application. In the embodiment shown in FIG. 6, computer systems 14, 14′ establish network connections with modem banks 116, 116′ using a serial line protocol, such as the Point-to-Point (PPP) protocol or the Serial Line Internet Protocol (SLIP). The POP servers 114, 114′ also establish packet routing and filtering functions to allow service personnel 182 connecting through the SPN 180 to access remote computer systems 14, 14′. Although only two POPs 110, 110′ are shown in FIG. 6, it should be understood that any number of POPs may be used to achieve geographic dispersity.

The address server 118 receives a request for an IP address to the requester and returns an IP address that is available for assignment. The address server maintains a pool of IP addresses, the range for which may be configured during address server 118 setup. The pool of IP address may be maintained as a text file, array of integers, linked list, or a doubly linked list. For embodiments in which the address server 118 is provided as a DHCP server, administration of the server 118 may be done using standard management tools provided by WINDOWS 2000.

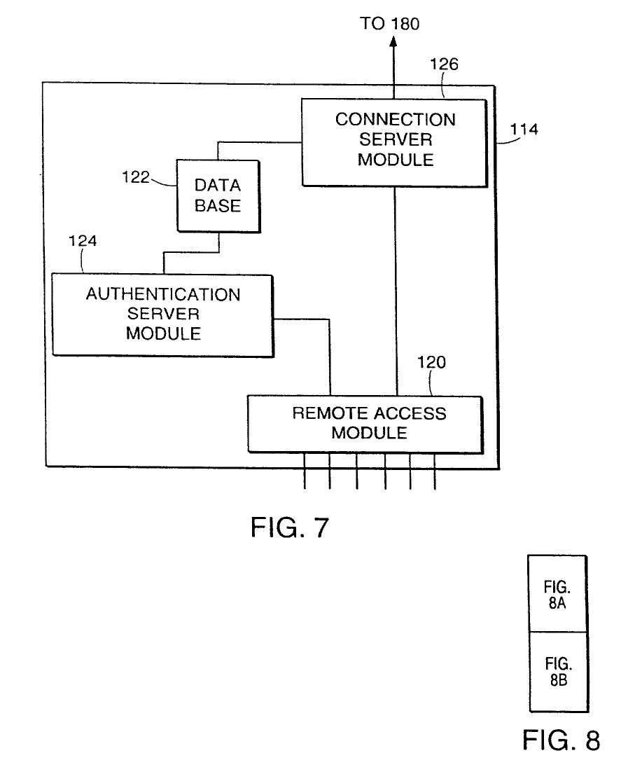

Referring now to FIG. 7, a POP server 114, 114′ is depicted in greater detail. In brief overview, a POP server 114, 114′ includes a remote access module 120, a local database 122, an authentication server module 124, and a connection server module 126.

The remote access module 120 establishes and manages connections with computer systems 14, 14′. The remote access server 120 may establish PPP connections for computer systems 14, 14′ either as an incoming call placed to the POP 100 by the system 14 or as an outgoing call placed by the POP 100 to the system 14. In some embodiments, the remote access module 120 places a call to a system 14, authenticates itself to the system 14, and then terminates the call. In these embodiments, the system 14 places a return call to the POP 100 to establish a connection. The POP 100 may authenticate itself using predefined passwords, shared secrets, or public key infrastructure techniques.

The remote access module 120 communicates with an authentication server module 124 to authenticate systems 14. The remote access module 120 monitors the state of all system connections and reports those changes to the connection server module 126. In certain embodiments, the remote access module 120 is provided as the RRAS portion of WINDOWS 2000, manufactured by Microsoft Corporation of Redmond, Wash. In other embodiments, the remote access module 120 is provided by a modified version of RRAS that supports the management of connections across multiple servers.

The authentication server module 124 verifies the authentication credentials of systems 14 and support personnel 182 seeking access to the POP 100. In one embodiment, the authentication server module 124 verifies a username and password against a password database stored in the database 122. In other embodiments, the authentication server module 124 verifies an encryption key, digital certificate, or digital signature. In other embodiments, the authentication server module 124 includes accounting functionality that tracks accounting statistics relating to connections or connection attempts. In one embodiment, the authentication server module is provided as the INTERNET AUTHENTICATION SERVICES module of WINDOWS 2000 manufactured by Microsoft Corporation of Redmond, Wash. Once the system 14 or support personnel 182 is authenticated, the authentication server module 124 transmits a request for an IP address to the address server 118.

The database 122 stores information associated with connections. In some embodiments, the database 122 stores information associated with active connections, such as time of connection, frequency of connection requests, and address associated with particular requests. The database 122 can be provided as an ODBC-compliant, flat file, multidimensional, or relational database.

The connection server module 126 manages connections to systems 14′ and requests from the centralized SPN 180. For example, in some embodiments the connection server module 126 maintains reference count values and idle timeout values for connections to determine if a particular connection may be terminated due to inactivity and notifies the SPN 180 when a connection is broken. The remote access module 120 communicates with the connection server module 126 through an Application Programming Interface. In some embodiments, the connection server module 126 API is provided as a dynamically linked library.

The connection server module 126 manages and directs the allocation of IP addresses to connections between the POP 100 and the system 14. The connection server module 126 is given an IP address by the address server 118, makes routing changes to assign that address to a connection, and transmits the address to SML 50 on the system 14.

Connection requests from the centralized SPN 180 may originate directly from service personnel 182 or they may originate from the connection server module 126′ of another POP server 114′. The SPN 180 and the various POPs 100 may communicate using a variety of connections including standard telephone lines, LAN, or WAN links (e.g., T1, T3, 56 kb, X.25), broad band connections (ISDN, Frame Relay, ATM) and wireless connections. Connections may be established using a variety of lower layer communication protocols (e.g. TCP/IP, IPX, SPX, NetBIOS, Ethernet, RS232, and direct asynchronous connection). In one embodiment, TCP/IP is used to communicate connection requests from the SPN 180 to the POP server 114.

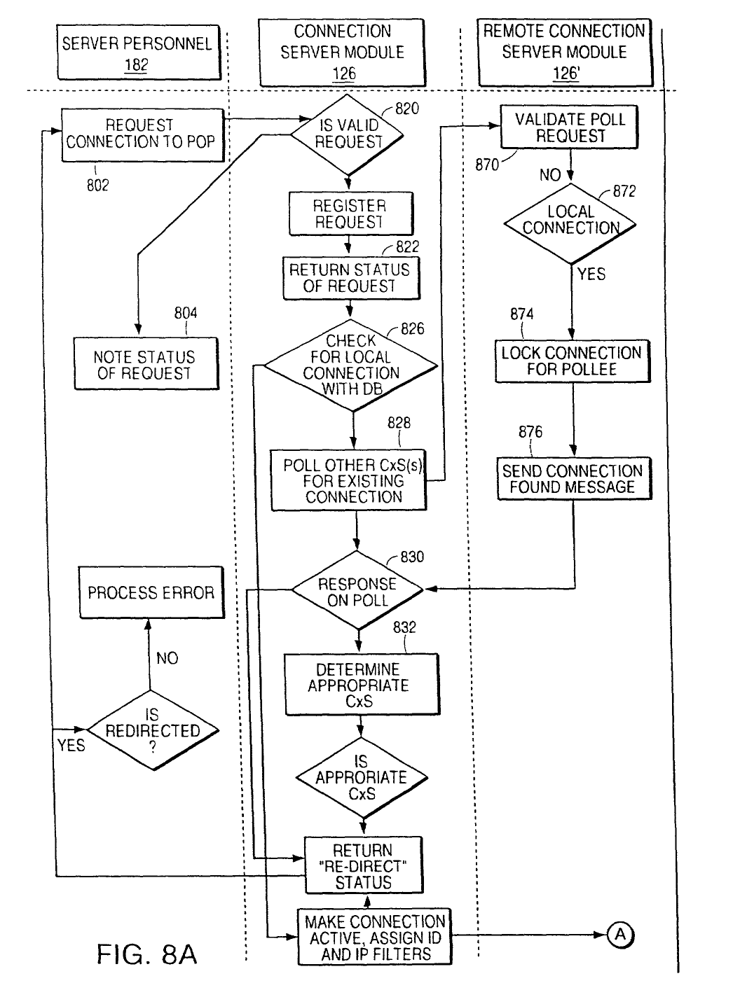

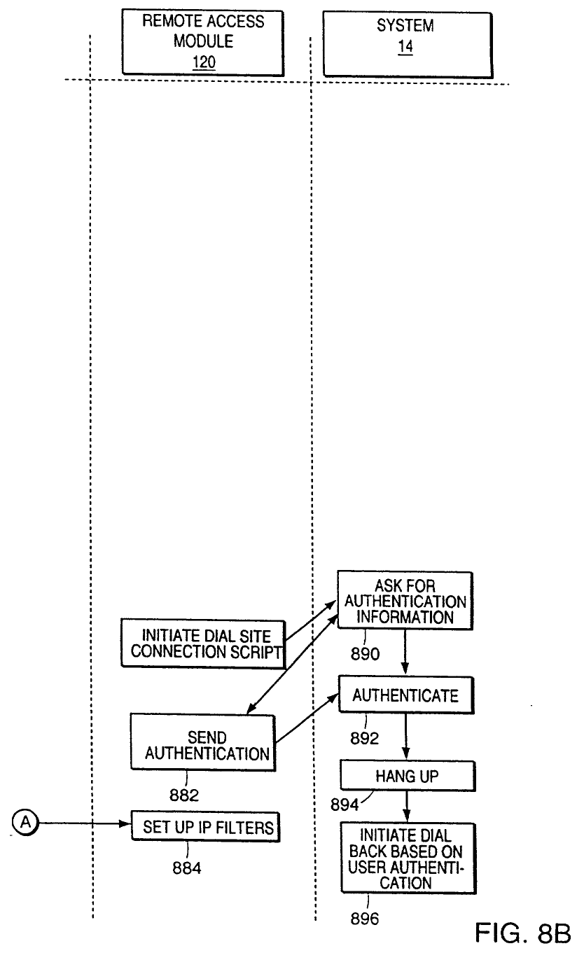

Referring now to FIG. 8, the functional flow diagram depicts the operation of the described service network when allowing service personnel 182 connections to systems 14. Service personnel 182 request connection to a system 14 (step 802). The service person 182 provides an identifier of the system to which the connection is desired, as well as authentication credentials such as a user name and password or a digital certificate. The request is transmitted through the centralized SPN 180 to a POP 100. The target POP 100 may be predetermined, selected by the service person 182, or selected on the basis of information included in the identifier. For example, in some embodiments the centralized SPN 180 maintains a database of identifiers and associated POP addresses. When a request to connect to a particular site is received, the identification information is used to lookup the address of the POP 100 with which the system 14 is associated. In certain embodiments, POP 100 associated with certain geographical regions and are identified by IP addresses.

The connection server module 126 of the identified POP 100 receives the connection request and validates the information associated with that request (step 820). If the authentication credentials associated with the request are not validated, the connection server module 126 denies access to the POP 100 and returns a denial message to service personnel 182. If the authentication credentials associated with the request are valid, then the connection server module 126 registers the request (step 822). The request registration is stored in the database 122 and associated with an identifier. The identifier allows the connection request to be identified for use in subsequent communications. In some embodiments, other information is stored with the request such as the time and the system to which the request connection is made. The connection server module 126 returns a successful status message (step 824) to the service personnel 182.

The connection server module checks the database 122 to determine if the connection to the identified system 14 already exists (step 826). If a local connection already exists, then the connection server module 126 activates the connection, and selects one or more address filters (step 840), and the address filters are sent to the remote access module. In response to this message, the remote access module 120 sets the address filters (step 884). For example, in some instances the address filters are IP filters.

IP filters provide the client system 14 with security against SPN-side malicious activity, since the filters can be set to reject all packets except those from the SPN 180. If no local connection to the system 14 exists then the connection server module 126 broadcasts a message to all other POPs 100 connected to the centralized SPN 180. The broadcast message polls the other connection server modules 126 to determine if they have existing connection to the desired system 14. The transmitted poll request include the authentication credential from the request.

Each of the other remote connection server modules 126′ validates the poll request 870 and checks for a local connection by querying their respective databases 122′. If no local connection exists, then the remote connection server module 126′ does not respond to the broadcast message. Otherwise, the remote connection server module locks the connection to the system 14 (step 874) and sends a message to the connection server module 126 indicating that a local connection exists with the system 14 (step 876).

The connection server module 126 determines if a response has been transmitted to its polling requests (step 830). In some embodiments, the connection server module 126 waits a predetermined amount of time and if no response is received in that period of time, it is assumed that no response to the poll has been received. If no response is received, that indicates that no POP 100 has a local connection to the desired system 14 and the connection server module 126 determines which connection server module 126 is the appropriate connection server module to initiate a local connection with the desired system 14. In some embodiments, this determination can be based on geographical location, i.e., which connection server module 126 is the nearest to the desired system 14. In other embodiments, this determination can be on the basis of the current processing activity in each POP 100. If the connection server module 126 determines that it is the appropriate connection server module to initiate the local connection, then it initiates a connection with the desired system 14.

If the connection server module 126 determines that it is not the appropriate connection server module to initiate the local connection then connection server module 126 returns status to the service personnel 182 indicating that its request should be redirected to the identified connection server module 126′ and the service personnel 182 transmits a connection request to the identified POP 100 (step 802).

In some embodiments, when the connection server module 126 determines that it is not the appropriate connection server module to initiate the local connection, then the status message returned by the connection server module 126 causes the software used by service personnel 182 to automatically transmit a connection request to the identified POP 100.

Referring back to step 880, the remote access module 120 initiates a connection with the desired system 14. The system 14 requests authentication information (step 890) which is transmitted by the remote access module 120 (step 882). The system 14 authenticates the request and, the authentication credentials are valid, allows access to the system 14. In some embodiments, the system 14 terminates the serial connection (step 894) upon authentication and initiates a return serial connection based on the validated authentication credentials (step 896).

Once a system connection has been successfully established, the remote access module 120 requests an IP address from the authentication server module 124. The requested IP address is transmitted to the SML 50 on the client system 14. In some embodiments, the IP address is transmitted using a remote procedure call. The assigned IP address allows communication with the system 14 to occur over the centralized SPN 180 and the POPs 100 rather than the public Internet. In some embodiments, two IP addresses are assigned to a system 14; one identifies the system 14; and a second IP address identifies the SML 50.

Once a system connection has been successfully established, the remote accesss module 120 assigns an IP address to the SML 50 on the client system. The assigned IP address allows communication with the SML 50 over the centralized SPN 180 and the POPs 100 rather than the public Internet. In some embodiments, two addresses are assigned: one to the SML 50 and one to the system 14. In one embodiment, the IP address assigned to the system 14 is done through a remote procedure call.

The SML 50 uses the IP address transmitted to it by the remote access module 120 to control traffic at the client system 14. IP filtering allows the SML 50 to block packets having associated addresses that are not intended for the system 14.

In one detailed embodiment, the system 14 makes a connection to the POP/centralized SPN as follows:

1. If the system 14 is initiating the connection, it performs a remote procedure call (“RPC”) to the SML 50 instructing it to establish a PPP connection to the POP/centralized SPN. The SML 50 can also initiate a connection for its own connection.

2. The SML 50 dials the POP/centralized SPN on its modem.

3. A POP/centralized SPN answers, the system 14 is authenticated and identified by the remote access module 120. A PPP session is established between the POP/centralized SPN and system 14.

4. During the establishment of the PPP connection, IP address T2 is assigned to the SML's 50 modem interface.

5. A POP/centralized SPN performs an RPC to the SML 50 to send a newly-assigned IP address T1 for the system 14.

6. The SML 50 receives the system IP address T1 from the POP/centralized SPN and modifies its routing table to allow packets coming from a POP/centralized SPN to be sent to the system IP address T1.

7. The SML 50 passes the system IP address T1 onto the system via a RPC.

8. The system assigns this address to the system 14 side of the SML 50 virtual network interface.

9. The POP/centralized SPN performs a RPC to the SML 50 to send a delivery IP address.

10. The SML 50 takes note of the delivery IP address, and passes it onto the system 14 via a RPC.

11. The system note of the delivery IP address.

12. The remote access module 120 registers the connected user (i.e., it makes note of the connection so that any request to attach to the site is directed to the existing connection).

13. Depending on the firewall architecture, the remote access module 120 may also communicate with the firewall to explicitly allow packets from the connected system through to the POP/centralized SPN.

14. At this stage an IP connection now exists between the POP/centralized SPN and customer system 14.

Outgoing (POP/centralized SPN to Customer system) connections are established as follows:

1. The POP/centralized SPN initiates a PPP connection to the SML 50 by dialing the SML's 50 modem.

2. The SML's 50 modem answers, POP/centralized SPN is authenticated and the PPP connection is up.

3. The SML 50 takes note of the user that connects, and terminates the PPP connection.

4. The SML 50 retrieves the dial-back phone number for that user, and dials its modem.

5. A POP/centralized SPN answers, the system 14 is authenticated and identified by the remote access module 120. A PPP session is established between the POP/centralized SPN and system 14.

6. During establishment of the PPP connection, IP address T2 is assigned to the SML's 50 modem interface.

7. A POP/centralized SPN performs an RPC to the SML 50 to send a newly-assigned IP address T1 for the system 14.

8. The SML 50 receives the system IP address T1 from the POP/centralized SPN and modifies its routing table to allow packets coming from a POP/centralized SPN to be sent to the system IP address T1.

9. The SML 50 passes the system IP address T1 onto the system via a RPC.

10. The system assigns this address to the system 14 side of the SML 50 virtual network interface.

11. The POP/centralized SPN performs an RPC to the SML 50 to send a delivery IP address.

12. The SML 50 takes note of the delivery IP address, and passes it onto the system 14 via a RPC.

13. The system takes note of the delivery IP address.

14. The POP/centralized SPN performs an RPC to the SML 50 to send the IP address B2 of the service system.

15. The SML 50 receives the service system IP address B2 from the POP/centralized SPN and modifies its routing table to allow packets intended for the service system to be sent via the PPP interface.

16. The SML 50 passes the service system IP address B2 onto the host via RPC.

17. The system 14 modifies its routing table to allow packets intended for the service system to be sent via the shared memory interface.

18. The remote access module 120 registers the connected user (i.e., it makes note of the connection so that any request to attach to the site is directed to the existing connection).

19. Depending on the firewall architecture, the remote access module 120 may also communicate with the firewall to explicitly allow packets from the connected system through to the POP/centralized SPN.

20. At this stage an IP connection now exists between the POP/centralized SPN and customer system 14. Firewall functionality is implemented by the SML 50 rejecting any packet not addressed to T1 or T2, since only the customer system 14 and the POP/centralized SPN know addresses T1 and T2.

Additional steps are required to implement firewall functionality when the customer system 14 uses the Microsoft WINDOWS operating system. To communicate successfully through the firewall functionality, packets sent from the customer system 14 to the POP/centralized SPN must bear source address T1. If instead the packets bear the permanent address P1 of the customer system 14, then packets sent to the customer system 14 from the POP/centralized SPN will be rejected by the SML 50.

The Microsoft WINDOWS operating system assigns the source address of packets based on the address of the default gateway to the POP/centralized SPN stored in the WINDOWS routing table. Since this gateway is the SML 50, the gateway address will either be T2 or the permanent address P2 of the SML 50 side of the virtual network interface. If the address is T2, then the packet source address will be T1 which, as discussed above, is the desired source address. If instead the gateway address is P2, then WINDOWS will assign P1 as the source address of the packets, which will not pass the firewall functionality.

However, the desired value T2 cannot be used as the default gateway in the WINDOWS routing table because the SML 50 will not respond to Address Resolution Protocol (ARP) requests using the T2 address coming from the client system 14 side of the SML 50. The PPP interface bearing the T2 address is on the POP/centralized SPN side of the SML 50 and is not associated by the SML 50 with the client system 14 side of the SML 50. That is, the SML 50 is only responsive to ARP requests using the T2 address that come from the POP/centralized SPN side of the SML 50.

Thus, the permanent address P2 of the virtual network interface of the SML 50 must be used as the gateway in the routing table, which prevents the source address of the packets from being set to T1, the proper source address.

In one embodiment, this problem is solved by assigning temporary address T4 to the SML 50 side of the virtual network interface which, as discussed above, is also identified with address P2. The use of T4 as the default gateway lets WINDOWS set the source address of packets from the client system 14 to T1 and, unlike the earlier scenario, the SML 50 will recognize and respond to ARP requests directed to the T4 address and coming from the client system 14 side of the SML 50.

Once a connection has been established with a client system 14, service personnel 182 can perform various operations on system 14 or access various parts of system 14 to monitor the system. Regardless of whether the SML 50 is in a boot or active state, it is in some embodiments useful for system personnel 182 to access video data corresponding to messages normally displayed on the display 26 of the system 14′. Such messages can provide valuable indicia of the state of the system 14′ as well as each of its installed elements. For example, BIOS messages typically indicate the version of the BIOS that may or may not be compatible with the hardware version of the system 14′. BIOS messages can also indicate whether there is an incompatibility between the CPU versions in multiprocessor configurations that may affect the operations of the system 14′. Another type of fault indicia includes messages from I/O controllers 24 that indicate if the BIOS of the I/O controller 24 has been loaded and that also provide the status and configuration information for devices that it controls. Other types of fault indicia typically displayed on the display 26 of the system 14′ include POST codes, memory contents, messages from software drivers, hardware and software interrupt messages, diagnostics results, etc.

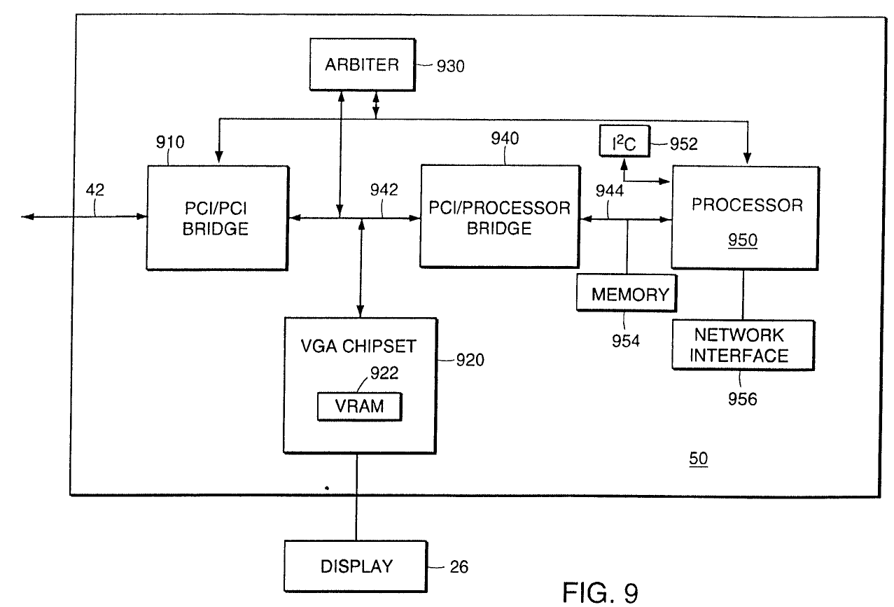

In one embodiment and with reference to FIG. 9, the SML 50 comprises a PCI/PCI bridge 910, a VGA chip set 920 with associated VRAM 922, an arbiter 930, a PCI/Processor bridge 940, a processor 950, an inter-integrated circuits serial interface (I²C) 952, a memory 954, and a network interface 956. The PCI/PCI bridge 910, such as a DEC 21153 PCI-PCI bridge/isolator, extends the system PCI bus 42 so that PCI devices on a local PCI bus 942 and sited on the SML 50 have visibility to the system 14′. An example of a PCI device that can be located on the SML 50 and which communicates via the local PCI bus 942 is the VGA chip set 920, such as the Cirrus Logic CL-GD5446 VGA controller. The VGA chip set 920 processes and renders the video data stored in the VRAM 622 for subsequent display on the server's display 26.

The PCI/Processor Bridge 940 (e.g., Tundra QSPAN PCI to Host bridge) enables the processor 950 (e.g., MPC860T I/O microprocessor and PowerPC core) to communicate with local and system PCI devices over a local processor bus 944 (e.g., Qbus). When performing a monitoring function, the processor 950 executes instructions stored in the memory 954 and accesses system and component information of the system 14′ via I²C logic 952 that has visibility on an I²C bus, via the system PCI bus 42, and via the local PCI bus 642. The processor 950 can also provide data to and receive instructions from a remote administrator via the network interface 956.

As previously discussed, the SML 50 enables a remote administrator to access messages displayed on the display 26 of the system 14′ in support of a troubleshooting session. Since the processor 950 has access to the VRAM 922 of the VGA chip set 920 via the local PCI bus 942, the processor 950 can programmatically read and write to VGA I/O and memory space. In one embodiment, the capture of the video data stored in the VRAM 922 involves the following steps: store the state of key VGA registers (not shown) in the VGA chip set 920, set the appropriate VGA registers to enable access to the VRAM 922, perform the VRAM 922 memory accesses, and restore the VGA register state for the system 14′.

Remote VGA accesses by the administrator via the local PCI bus 942 result in the modification of the VGA registers and thus may result in a conflict when concurrent data access requests are received from the system 14′. The conflict introduced by concurrent accesses from the system 14′ (such as by CPU 20) and the processor 950 of the SML 50 can result in a corrupted VGA state or in an inability to read video data from the VRAM 922. This problem is resolved in one embodiment, through the use of a customized arbiter 930 that provides an additional pin that, when asserted by a blocking command issued by the processor 950, ignores/blocks requests from the PCI/PCI bridge 910 and thus enables the processor 950 to obtain exclusive access to the VGA chip set 920. The arbiter may be provided as a programmable logic device (PLD), field-programmable gate array (FPGA), or application-specific integrated circuit (ASIC). The processor 950 can then complete the transactions requested by the administrator, reset the VGA registers for subsequent use by CPU 20, and then issue a signal/command to the arbiter 930 that undoes the previous blocking command and enables the VGA chip set 920 to service data access requests received from the PCI/PCI bridge 910.

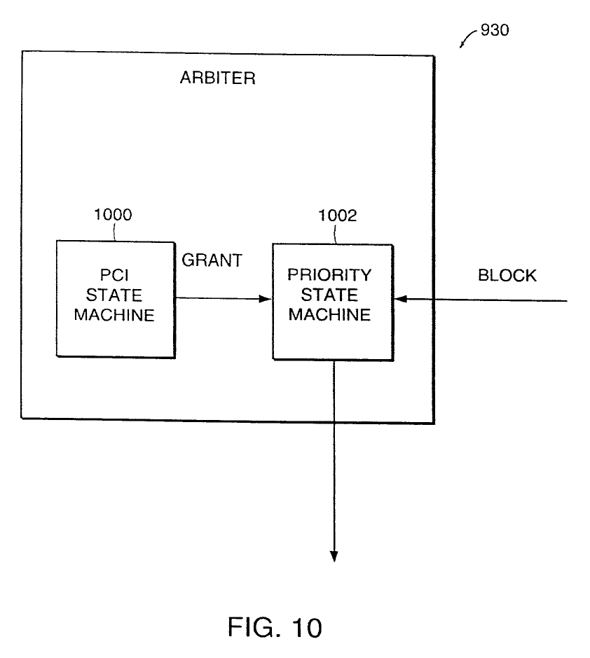

In one embodiment, referring to FIG. 10, the arbiter 930 includes two state machines: a PCI state machine 1000 that arbitrates access to the local bus 42 and a priority state machine 1002 that addresses blocking commands issued by the processor 950. The GRANT signal of the PCI state machine 1000 passes through the priority state machine 1002, which in turn decides whether the system 14 or the processor 950 has access to the VGA chip set 920.

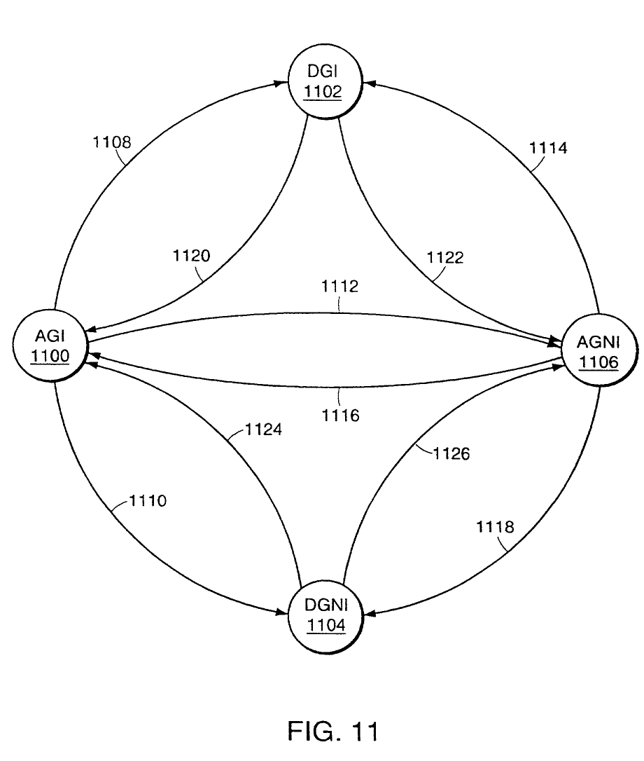

In one embodiment, referring to FIG. 11, in normal operation the PCI state machine 1000 has four internal states and a register. When the arbiter 930 is powered on or receives a reset signal, the PCI state machine 1000 enters the Assert Grant Idle (AGI) state 1100. In the AGI state 1100, a default device (at power up) or the last granted device (when entering from another state) controls the bus 42 until a request occurs. When entering this state the GRANT signal is asserted and the register is updated with the ID of the device being granted. As long as the bus 42 is idle, no error conditions occur, and the device requesting the bus 42 is the one currently controlling the bus 42, the PCI state machine 1000 does not change its state.

If a device other than the currently granted device requests the bus 42 and the bus is idle, then the PCI state machine 1000 will transition to the Deassert Grant Idle (DGI) state 1102 through transition 1108. If a device other than the currently granted device requests the bus 42 and the bus is not idle, then the PCI state machine 1000 will transition to the Deassert Grant Not Idle (DGNI) state 1104 through transition 1110. These states are described in more detail below. The state of the bus 42 determines the next state of the PCI state machine 1000 because the grant lines need to be deasserted for one clock cycle before another device's request can be granted. On the other hand, if the bus 42 becomes busy and there are no requests or the only requests are from the device currently granted, then the PCI state machine 1000 will transition from AGI state 100 into the Assert Grant Not Idle (AGNI) state 1106 through transition 1112.

The AGNI state 1106 may be entered from the AGI, DGI, or DGNI states. When entering this state the GRANT signal is asserted and the register is updated with the ID of the device being granted. If the bus 42 goes idle and a request from a device other than the currently-granted device is received, the PCI state machine 1000 transitions into the DGI state 1102 through transition 1114 to avoid potential contention on the bus 42 when granting to another device. If the bus 42 becomes idle or is requested by the currently-granted device, then the PCI state machine 1000 transitions back to its initial AGI state 1100 through transition 1116. On the other hand, if a request comes from a device that is not the currently-granted device without the bus 42 going idle, then the PCI state machine 1000 transitions to the DGNI state 1104 through transition 1118, performing hidden arbitration as discussed below.

The DGI state 1102 is necessary to allow for turnaround when re-assigning the bus 42 to avoid bus contention. This state can only be entered from an asserted state (i.e., AGI state 1100 or AGNI state 1106) when the bus 42 goes idle and a device other than the currently-granted device requests the bus 42. In these cases, the bus 42 is deasserted upon entering this state and the initial AGI state 1100 is entered through transition 1120. On the next transition, the PCI state machine 1000 will change to either of the asserted states (i.e., AGI state 1100 through transition 1120 or AGNI state 1106 through transition 1122), depending on whether or not the bus 42 is idle.

The DGNI state 1104 essentially serves the same function as the DGI state 1102, permitting transition to both asserted states (i.e., AGI state 1100 and AGNI state 1106). The transition to AGNI state 1106 permits the arbiter 930 to support hidden arbitration, since the bus 42 will have been granted to a new device without ever going idle. If the bus 42 goes idle while in this state, the PCI state machine 1000 transitions to the default or initial state through transition 1124 until a new transaction is initiated. If the bus 42 is not idle, then the PCI state machine 1000 transitions to the AGNI state 1106 through transition 1126 until a new transaction is initiated. This state can be entered from either of the asserted states (i.e., AGI state 1100 or AGNI state 1106) depending on whether the bus 42 is idle and which device is requesting the bus 42.

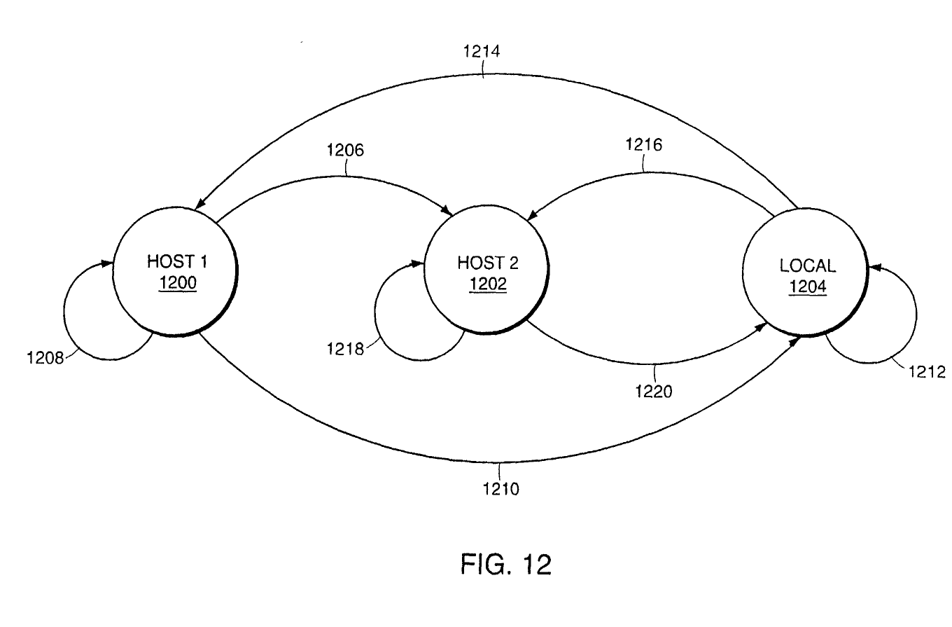

The GRANT signal from the PCI state machine 1000 is an input to the priority state machine 1002. The blocking command from the processor 950 is a second input to the priority state machine 1002, which operates so as to prevent the system 14′ from accessing the VGA chipset 920 when the blocking command is asserted. Referring to FIG. 12, after a reset, the priority state machine 1002 is in HOST1 state 1200, whereby the system 14′ may access the VGA chip set 920 through the bus 42. If the system 14′ has higher priority and does not need to be blocked and the grant signal is asserted, then the priority state machine 1002 transitions to the HOST2 state 1202 through transition 1206. If the grant signal is not asserted, the priority state machine 1002 remains in HOST1 state 1200 through transition 1208.

The priority state machine 1002 remains in HOST2 state 1202 through transition 1218 as long as grant is not asserted. When grant is asserted, the priority state machine 1002 transitions from HOST2 state 1202 to LOCAL state 1204 through transition 1220.

If the priority of the system 14′ is equal or the processor 950 has issued a blocking request and grant is asserted, then the priority state machine 1002 transitions from HOST1 state 1200 to LOCAL state 1204 through transition 1210. In LOCAL state 1204, the system 14 is blocked from accessing the bus 42. As long as the system 14′ must be blocked, the priority state machine stays in LOCAL state through transition 1212. When blocking is no longer necessary, the finite state machine transitions to HOST1 mode through transition 1214 or HOST2 mode through transition 1216, depending on whether the system 14 has priority. Video may then be transmitted to service personnel 182 using an appropriate video transmission protocol, such as the Virtual Network Computing (VNC) protocol.

Having described certain embodiments of the invention, it will now become apparent to one of skill in the art that other embodiments incorporating the concepts of the invention may be used. In particular, the functional divisions made in connection with the block diagrams of the present discussion have been made to enhance clarity of the discussion, and other divisions or integrations of the described functions are within the scope of the invention. Therefore, the invention should not be limited to certain embodiments, but rather should be limited only by the spirit and scope of the following claims.

What is claimed is:

1. A method for dynamically extending a firewall, the method comprising the steps of:
(a) establishing a connection with a remote system;
(b) receiving an identifier from the remote system; and
(c) using the identifier to filter information received through the connection with the remote system.

2. The method of claim 1 wherein step (a) comprises initiating a serial connection with the remote system.

3. The method of claim 1 wherein step (a) comprises:
(a-a) contacting the remote system;
(a-b) providing the remote system with authentication credentials;
(a-c) receiving a serial connection from the remote system in response to the authentication credentials.

4. The method of claim 1 wherein step (b) comprises:
(b-a) requesting an identifier from the remote system; and
(b-b) receiving an identifier in response to the request.

5. The method of claim 1 wherein the identifier from the remote system is an Internet Protocol (IP) address.

6. The method of claim 1 wherein step (c) comprises the steps of:
(c-a) receiving a packet of information from the remote system;
(c-b) examining the packet of information to determine its destination address
(c-c) comparing the destination address to the identifier received from the remote system;
(c-d) accepting the packet if its destination address matches the identifer; and
(c-e) rejecting the packet if its destination address does not match the identifier.

7. The method of claim 1 wherein the remote system chooses the identifier transmitted from a pool of identifiers.

8. The method of claim 1 further comprising the step:
(e) assigning the identifier received from the remote system to the local system.

9. The method of claim 8 further comprising the steps:
(f) receiving a second identifier from the remote system;
(g) assigning the second identifier to service management logic on the local system.
(h) using the second identifier to filter information received through the connection with the remote system;

10. A method for dynamically extending a firewall, the method comprising the steps of:
(a) receiving a connection from a remote system;
(b) receiving an identifier from the remote system; and
(c) using the identifier to filter information received through the connection with the remote system.

11. The method of claim 10 wherein step (a) comprises the initiation of a serial connection by a remote system.

12. The method of claim 10 wherein step (a) comprises:
(a-a) receiving a call from the remote system;
(a-b) receiving authentication credentials from the remote system;
(a-c) initiating a serial connection with the remote system in response to the authentication credentials.

13. The method of claim 10 wherein step (b) comprises:
(b-a) requesting an identifier from the remote system; and
(b-b) receiving an identifier in response to the request.

14. The method of claim 10 wherein the identifier from the remote system is an Internet Protocol (IP) address.

15. The method of claim 10 wherein step (c) comprises the steps of:
(c-a) receiving a packet of information from the remote system;
(c-b) examining the packet of information to determine its destination address
(c-c) comparing the destination address to the identifier received from the remote system;
(c-d) accepting the packet if its destination address matches the identifer; and
(c-e) rejecting the packet if its destination address does not match the identifier.

16. The method of claim 10 wherein the remote system chooses the identifier transmitted from a pool of identifiers.

17. The method of claim 10 further comprising the step:
(e) assigning the identifier received from the remote system to the local system.

18. The method of claim 17 further comprising the steps:
(f) receiving a second identifier from the remote system;
(g) using the second identifier to filter information received through the connection with the remote system;
(h) assigning the second identifier to service management logic on the local system.
